(19) United States
(12) Patent Application Publication
(10) Pub. No.: US 2012/0006306 A1
(43) Pub. Date: Jan. 12, 2012

(54) Housing for an Internal Combustion Engine with a PCV Valve for Crankcase Ventilation, and a Method for Attaching a PCV Valve to a Housing

(75) Inventors: Michael Boehm, Koberg (DE); Artur Knaus, Hamburg (DE)

(73) Assignee: DICHTUNGSTECHNIK G. BRUSS GMBH & CO. KG, Hoisdorf (DE)

(21) Appl. No.: 13/174,062

(22) Filed: Jun. 30, 2011

(30) Foreign Application Priority Data
Jul. 6, 2010 (DE) 102010026284.6

(51) Int. Cl. F01M 13/00; B23P 19/00

(52) U.S. Cl. 123/572; 29/428

(57) ABSTRACT

A housing for an internal combustion engine with a PCV valve for crankcase ventilation, including a valve housing and a valve insert, wherein the valve housing comprises a pressure-side opening which is connected to a pressure space carrying blow-by gases and a suction-side opening which is connected to a suction space, wherein the valve insert includes a valve body displaceably guided in the valve housing and a spring, wherein in an pressure-less state the valve body is pre-loaded towards, and rests on, a valve seat, wherein the valve body, exclusively controlled by a defined positive pressure in the pressure space relative to the suction space, is automatically displaceable to an open position against the force of the spring in order to provide a ventilation opening for blow-by gases between the pressure space and the suction space, wherein the valve housing includes two separate valve housing parts, wherein the valve seat is integrated into a first valve housing part and the first valve housing part is integrated into the housing forming a single piece, and a second valve housing part can be connected to the first valve housing part with the valve insert inserted in between to form a complete valve, and wherein the pressure-side opening is provided in the first valve housing part and the suction-side opening is provided in the second valve housing part.

The present invention relates to a housing for an internal combustion engine with a PCV (Positive Crankcase Ventilation) valve attachable thereto for crankcase ventilation, and a method for attaching a PCV valve to such a housing.

It is known to connect a valve to an internal combustion engine housing by use of a fastening means, for example a screwed connection, or by other methods, for example by welding. However, it is a disadvantage of the known connecting solutions that for example narrow tolerances for the screw-in torque must be met or additional fastening elements are needed. Mounting a valve in the housing by screwing or welding is relatively time-consuming.

From DE 10 2008 005 409 A1, a cylinder head cover comprising an integrated valve housing is known. The valve body can be inserted through the suction-side opening of the valve housing. To prevent the valve body from falling out of the valve, an additional bearing of the valve body in the valve housing is required. Due to the missing spring for pre-loading the valve body the valve is not generic.

DE 41 36 894 C1 discloses a non-generic pressure control valve comprising a diaphragm which, by use of a spring, provides a ventilation or de-ventilation opening between an inlet space (pressure space) and an exhaust space (suction space) under usual pressure conditions. A high negative pressure relative to the atmosphere in a channel formed by the inlet space and the exhaust space loads the diaphragm and effects the pressure control valve to be closed against the force of the spring. EP 1 559 876 A2, DE 20 2005 013 734 U1 and DE 603 14 698 T2 disclose similarly operating pressure control valves for crankcase ventilation. Such pressure control valves for crankcase ventilation generally differ from a generic PCV valve in that the control pressure of a pressure control valve does not depend on a pressure difference between the pressure space and the suction space, i.e. between two points within the area through which blow-by gases flow, but on a negative pressure relative to an external reference pressure, normally atmosphere pressure, at one point of the area through which blow-by gases flow.

U.S. Pat. No. 6,418,918 32 discloses an intake manifold for an internal combustion engine with a housing carrying blow-by gases. A valve housing with a hollow space is formed as a part of the housing. A PCV valve arrangement is located in the hollow space.

DE 10 2008 031 638 A1 discloses a plastic oil pan comprising a through hole through which a functional component located inside the oil pan can be supplied with a medium through the wall of the oil pan. DE 20 2006 001 144 U1 discloses an oil pan for an internal combustion engine comprising an oil outlet opening and a corresponding oil outlet device which can be adjusted manually or by use of a for example nozzle-shaped tool. US 2002 148662 A1 discloses a lubricant system for a snowmobile engine.

It is the object of the present invention to provide an internal combustion engine housing which can be manufactured at low costs, and a method for attaching a valve to such housing, wherein the valve can be easily and quickly connected to the housing.

This object is solved according to the invention with the features of the independent claims. Owing to the two-part design of the valve housing, the valve insert can easily be inserted into a valve interior volume formed between the valve housing parts, and the second valve housing part can then be connected to the first valve housing part to form a complete valve. An additional protection of the valve insert against falling out (loss-proof design) is not required. Due to the integration of the valve seat into the first valve housing part as one piece and the integration of the first valve housing part into the housing as one piece, the total number of parts can be reduced and a separate connecting means for connecting the first valve housing part to the housing is dispensable. Arranging the suction-side opening in the second valve housing part allows a particularly easy discharge of the blow-by gases into the air intake system, for example by providing an exterior mounting at the suction-side opening for a pipe or a hose.

Preferably, the pressure-side opening and/or the suction-side opening of the valve is smaller than the cross section of the valve body. The valve body thus is held in the valve housing in a loss-proof manner without further measures. As the valve insert in this case cannot be inserted through the pressure-side opening and/or the suction-side opening of the valve housing, the inner diameter of the valve housing in the region of the connection between the first and the second valve housing part is preferably larger than the cross section of the valve body. The valve insert thus can be inserted between the valve housing parts in this connecting region.

In the following, the invention is described in more detail with reference to the attached figures. The figures show:

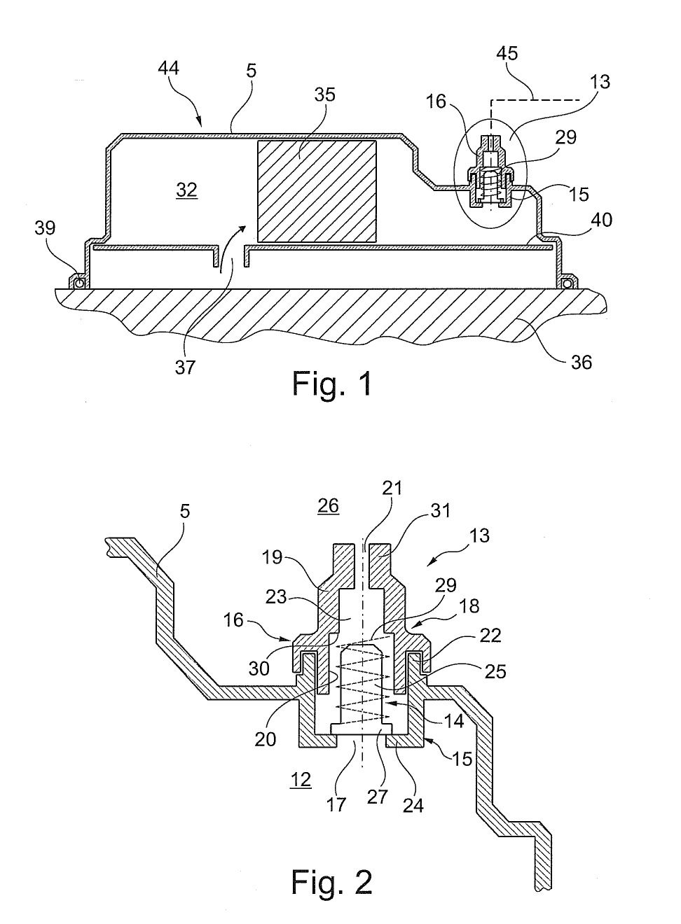

FIG. 1: a schematic cross section of a cylinder head cover;

FIG. 2: an enlarged cut-out of FIG. 1 in the region of the ventilation valve;

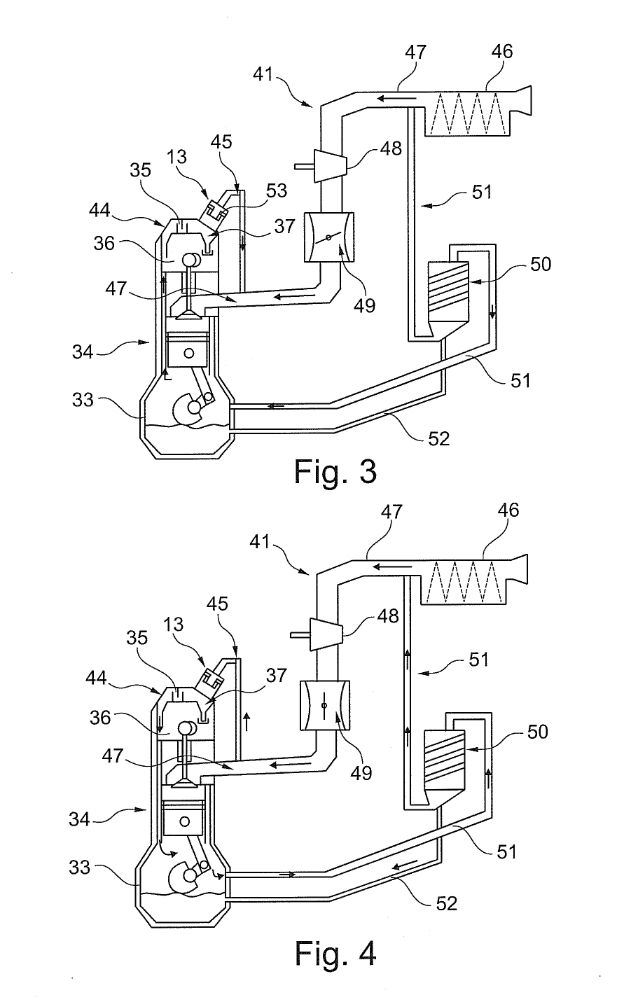

FIG. 3: a schematic cross section of an internal combustion engine; and

FIG. 4: a schematic cross section of an internal combustion engine running at full load operation.

In the housing 5 of the cylinder head cover 44 a duct or interior volume 32 is formed into which blow-by gases from the crankcase 33 of an internal combustion engine 34, in particular an Otto engine, are input (see FIGS. 3 and 4) through an opening 37 which can be provided for example in a bottom plate (baffle) 40 extending across the cylinder head cover 5.

The cylinder head cover 44 is sealed against the cylinder head 36 of the internal combustion engine 34 for example by use of a static seal 39.

The blow-by gases are conducted through the duct or interior volume 32. An oil separation device 35 only schematically indicated in FIG. 1 can be provided in the housing 5 in order to separate oil from the blow-by gases conducted through the duct 32. The separated oil is returned into the oil space of the internal combustion engine 34 by use of an oil return not shown in the Figures. The oil return can for example be located in the bottom plate (baffle) 40.

A ventilating valve 13 for crankcase ventilation illustrated in more detail in FIG. 2 and comprising a valve housing 18 and a valve insert 14 located therein is mounted to the housing 5. The valve housing 18 consists of a first valve housing part 15 with a pressure-side opening 17 and a separate second valve housing part 19 with a suction-side opening 21. The pressure-side opening 17 is coupled to a pressure space 12 through which blow-by gases flow, here the interior volume 32 of the cylinder head cover 5 provided with an oil separator 35. The suction-side opening 21 is connected to a suction space 26 which in particular is connected to the air intake system 41 of the engine 34. For this purpose, a mounting 31 for being connected to a pipe 45, in particular a hose, is provided at the outer surface of the second valve housing part 19 in the region of the suction-side opening 21. The pipe 45 in particular is coupled to the air intake system 41 of the internal combustion engine 34, see FIGS. 3 and 4.

The first valve housing part 15 is integrated into the housing 5, i.e. it is formed integrally with the same as one piece. Particularly the first valve housing part 15 is manufactured together with the rest of the housing 5 in the same manufacturing step. In the case of a housing 5 made of plastic, in particular a thermoplastic, the first valve housing part 15 is manufactured together with the rest of the housing 5 for example in the same mold by injection molding. The second valve housing part 19 is a separate, preferably one-piece part, and can for example be made of plastic, in particular a thermoplastic. In the operating state the second valve housing part 19 is connected to the first valve housing part 15 by suitable fastening means 22, for example by welding or clip attachment. If required, a static seal not shown in the Figures can be provided between the first valve housing part 15 and the second valve housing part 19, with a single static seal usually being sufficient.

A preferable one-piece valve body 25 having for example a rotationally symmetric shape is located in the valve housing 18. For this purpose, the first valve housing part 15 and/or the second valve housing part 19 comprises a receptacle 42 and 43, respectively, forming a valve interior volume 23 in which the valve body 25 is held in a loss-proof manner when the valve housing 13 is assembled.

The valve body 25 can be displaced between a close position and an open position. In FIG. 1, the valve body 25 is in a close position. A valve seat 24 is formed integrally with the first valve housing part 15, i.e. it is integrated into the same. In the close position the valve body 25 rests on the valve seat 24 so that the pressure-side opening 17 is completely closed. The valve body 25 is pre-loaded towards the close position via a spring 29 which is supported at the inner surface of the second valve housing part 19. Therefore, in a pressure-less state, for example when the motor is not running, the valve 13 is in the close state. The valve body 25 preferably comprises at one end a projection 27, for example in the form of a flange or a collar, for supporting the spring 29. The spring 29 is put around the preferably cylindrical valve body 25 with play. The second valve housing part 19 preferably also comprises a projection 30 for supporting the spring 29.

The valve body 25 and/or the spring 29 are preferably inserted only loosely into the valve housing 18. An attachment of the spring 29 to the valve body 25 or to the valve housing 18 can thus be dispensed with, just as a possible attachment of the valve body 25 to the valve housing 18. In addition to the housing 5 and apart from a potential seal between the valve housing parts 15, 19, only three components are required for the valve 13, namely the second valve housing part 19, spring 29 and valve body 25. Thereby, the number of the required components can preferably be limited to a minimum.

The valve body 25 is displaceably guided in the valve housing 18, here in the second valve housing part 19. For this purpose, the inner diameter of the second valve housing part 19 is adapted to the outer diameter of the valve body 25 or the outer diameter of the spring 29.

Due to a positive pressure in the pressure space 12 relative to the pressure prevailing at the suction opening 21 the valve body 25 is displaced from the close position shown in FIG. 1 to a not shown open position against the spring force of the spring 29. The blow-by gases can flow around the complete outer surface of the valve body 25 in the open position as long as the positive pressure in the pressure space 12 is sufficient for maintaining the valve body 25 in an open position against the spring force of the spring 29. Thus, blow-by gases flow through both the pressure space 12 and the suction space 26.

The valve 13 is a PCV (Positive Crankcase Ventilation) valve. This means that, contrary to non-generic pressure control valves, the displacement of the valve body 25 in the PCV valve 13 is controlled by a positive pressure in the pressure space 12 relative to the pressure in the suction space 26 only, without relation to an external reference pressure. Thus, the PCV valve 13 does not have a diaphragm (i.e. it is free of a flexible diaphragm) and blow-by gases flow through the entire interior 23 of the PCV valve 13, whereas non-generic pressure control valves comprise a reference pressure space which is separated by a flexible diaphragm and through which no blow-by gases flow.

The valve is assembled by loosely sliding the spring 29 over the valve body 25 and loosely inserting the valve insert 14 consisting of valve body 25 and spring 29 into the valve interior volume 23 formed by the valve housing parts 15, 19. This is possible due to the comparatively large diameter of the valve housing parts 15, 19 in the region 16 of the connecting means 22, whereas the valve body 25 or the valve insert 14 cannot be inserted through the suction and pressure openings 17, 21 having a smaller cross section. After inserting the valve insert 14, the second valve housing part 19 is attached to the first valve housing part 15 by use of suitable fastening means 22.

A preferred application of the PCV valve 13 for ventilating the crankcase 33 of an internal combustion engine 34 is illustrated in FIG. 3. The air intake system 41 as usual includes an air filter 46, an intake pipe 47, possibly a compressor 48 in the intake pipe 47, and a throttle valve 49. Downstream of the throttle valve 49, i.e. between throttle valve 49 and the carburetion in the engine 34, the pipe 45 ends in the air intake system 41, in particular in the intake pipe 47. In FIG. 3 the PCV valve 13 is in the opened position in which the valve body 25 is lifted off the valve seat 24, and a ventilation of blow-by gases out of the crankcase 33 into the intake pipe 47 downstream of the throttle valve 49 is effected.

In the embodiments according to FIGS. 3 and 4 the oil separator 35 in the cylinder head cover 44 is for example a partial load separator, wherein the crankcase ventilation is effected via the oil separator 35 and the PCV valve 13 when the engine runs with idle or partial load as shown in FIG. 3. For full load operation a separate full load separator 50, for example a cyclone separator, is provided which, on the one hand, is connected to the crankcase 33 via ventilation pipes 51 and, on the other hand, is connected to the air intake system 41 up-stream of the throttle valve 49, in particular in the section between the air filter 46 and the throttle valve 49, and expediently comprises an oil return line 52 for returning separated oil into the engine 34. In full load operation, the crankcase ventilation in this embodiment is effected via the full load separator 50 as shown in FIG. 4. In idle or partial load operation the full load separator 50 can serve to aerate the crankcase 33 as shown in FIG. 3.

In a further embodiment illustrated in FIG. 4, the PCV valve 13 besides providing a ventilation functionality can also provide an aeration functionality. For example for a charged Otto engine running at full load operation (throttle valve open) an aeration of the crankcase 33 can be provided via the valve 13 in the close position of the valve body 25, as shown in FIG. 4. For this purpose, the valve 13 preferably provides a defined aeration/ventilation opening 53 which is provided at any time and independent of the position of the valve body 25. This can be achieved for example by openings, slits or channels in the valve body 25 and/or the valve seat 24.

A separate full load separator 50 is not compulsory, for example if the separation capacity of the oil separator 35 in the cylinder head cover 44 is sufficient for full load operation.

The housing 5 is not limited to a cylinder head cover 44; it can also be another housing conducting blow-by gas for the crankcase ventilation of an internal combustion engine 34.

1. A housing for an internal combustion engine with a PCV valve for crankcase ventilation, including a valve housing and a valve insert, wherein the valve housing comprises a pressure-side opening which is connected to a pressure space carrying blow-by gases and a suction-side opening which is connected to a suction space, wherein the valve insert includes a valve body displaceably guided in the valve housing, and a spring, wherein in a pressure-less state the valve body is pre-loaded towards, and rests on, a valve seat, wherein the valve body, exclusively controlled by a defined positive pressure in the pressure space relative to the suction space, is automatically displaceable to an open position against the force of the spring in order to provide a ventilation opening for blow-by gases between the pressure space and the suction space, wherein the valve housing includes two separate valve housing parts, wherein the valve seat is integrated into a first valve housing part and the first valve housing part is integrated into the housing forming a single piece, and a second valve housing part can be connected to the first valve housing part with the valve insert inserted in between to form a complete valve, and wherein the pressure-side opening is provided in the first valve housing part and the suction-side opening is provided in the second valve housing part.

2. The housing as claimed in claim 1, wherein the pressure-side opening of the valve is smaller than the cross section of the valve body.

3. The housing as claimed in claim 1, wherein the suction-side opening of the valve is smaller than the cross section of the valve body.

4. The housing as claimed in claim 1, wherein in a connecting region between the first and the second valve housing part the inner diameter of the valve housing is larger than the cross section of the valve insert.

5. The housing as claimed in claim 1, wherein the valve body is supported against the second valve housing part via the spring.

6. The housing as claimed in claim 1, wherein the valve comprises at least one opening for aerating the pressure space.

7. The housing as claimed in claim 1, wherein the second valve housing part comprises a mounting for a pipe or hose.

8. The housing as claimed in claim 1, wherein the suction-side opening in the second valve housing part is connected to an air intake system of an internal combustion engine via a pipe.

9. The housing as claimed in claim 8, wherein the pipe or hose ends in the air intake system downstream of a throttle valve.

10. A method for attaching a valve to an internal combustion engine housing, wherein the valve comprises a valve housing with a pressure opening and a suction opening and a valve insert positioned in the valve housing comprising a movable valve body, wherein the valve housing includes two separate valve housing parts, wherein a first valve housing part is integrated into the housing forming a single piece, comprising inserting a valve insert into a valve interior volume formed between the valve housing parts, and connecting the second valve housing part to the first valve housing part to form a complete valve.
